(19) United States
(12) Patent Application Publication
(10) Pub. No.: US 2009/0020930 A1
(43) Pub. Date: Jan. 22, 2009

(54) Strut Top Mount With Dual Axial Rate Tuning

(75) Inventor: Todd M. Wirges, Ann Arbor, MI (US)

Correspondence Address: FREUDENBERG-NOK GENERAL PARTNERSHIP;LEGAL DEPARTMENT, 47690 EAST ANCHOR COURT, PLYMOUTH, MI, 48170-2455, US

(73) Assignee: FREUDENBERG-NOK GENERAL PARTNERSHIP, Plymouth, MI (US)

(21) Appl. No.: 11/779,496

(22) Filed: Jul. 18, 2007

(51) Int. Cl. F16F 7/104

(52) U.S. Cl. 267/140.13

(57) ABSTRACT

A mount assembly for use in a vehicle includes a primary component sandwiched between a pair of secondary components. The primary component is secured to a first member of the vehicle, and the secondary components are secured to a second member of the vehicle. The primary component has a tuned performance characteristics different than the tuned performance characteristics of the secondary components. Each of the secondary components function in series with the primary component between the first and second members such that the mount assembly has multi-rate decoupled dynamic stiffness performance.

### FIELD

The present disclosure relates to mounts and mount assemblies for use in vehicles, especially top mounts for strut assemblies.

### BACKGROUND

The statements in this section merely provide background information related to the present disclosure and may not constitute prior art.

Mounts are utilized in vehicles to help provide isolation from vibrations and other forces. For example, vehicle suspension systems can utilize top mounts disposed between vehicle frames and suspension components. Conventional top mounts have a relatively high stiffness providing a single rate performance (tuning behavior). However, as vehicles can experience a broad range of vibrations and other forces, it would be desirable for a mount or mount assembly to have multi-rate (multiple tuning behaviors under differing circumstances) functionality.

### SUMMARY

The present disclosure provides a mount assembly. The mount assembly includes a first component secured to a first member, the first component having first tuned performance characteristics. The mount assembly further includes a second component secured to a second member, the second component having second tuned performance characteristic different than said first tuned performance characteristics. The second component is engaged in series with the first component for transmitting forces between the first and second members. The mount assembly also includes a third component secured to the second member, the third component having third tuned performance characteristic different than said first tuned performance characteristics. The third component is engaged in series with the first component for transmitting forces between the first and second members. The first component is disposed between the second and third components. The base material type, stiffness/characteristics of that material, and shape all impact the tuned performance characteristic behavior of the three components.

The present disclosure further provides a vehicle suspension assembly. The vehicle suspension assembly includes a vehicle frame adapted to support a body of a vehicle, a strut rod adapted to be coupled to a vehicle suspension system, and a first vibration absorbing mount component secured to the vehicle frame and slidably coupled to the strut rod, the first vibration absorbing mount component having first tuned performance characteristics. The vehicle suspension assembly further includes second and third vibration absorbing mount components secured to the strut rod on opposite sides of the first vibration absorbing mount component. Each of the second and third vibration absorbing mount components are engaged in series with the first vibration absorbing mount component for transmitting forces between the vehicle frame and the strut rod. The second and third vibration absorbing mount components have second and third tuned performance characteristics, respectively, the first tuned performance characteristics being different than the second and third tuned performance characteristics.

The present disclosure also provides a method of mounting a vehicle suspension system. The method includes securing a primary vibration absorbing mount component to a vehicle frame and movably coupling the primary vibration absorbing mount component to a member of the vehicle suspension system. The method further includes positioning a pair of secondary vibration absorbing mount components on the member at opposing sides of the primary vibration absorbing mount component so that each of the secondary vibration absorbing mount components are engaged in series with the primary vibration absorbing mount component for transmitting forces between the vehicle frame and the member. Additionally, the primary vibration absorbing mount component has different tuned performance characteristics than the secondary vibration absorbing mount components.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a schematic illustration of a mount assembly according to the principles of the present disclosure;

FIG. 2 is a cross sectional view of a strut assembly including a mount according to the principles of the present disclosure; and

FIG. 3 is a portion of the cross sectional view of FIG. 2.

### DETAILED DESCRIPTION

The following description is merely exemplary in nature and is not intended to limit the present disclosure, application, or uses. It should be understood that throughout the drawings, corresponding reference numerals indicate like or corresponding parts and features.

According to the principles of the present disclosure, a mount assembly for use in a vehicle includes a primary component sandwiched between a pair of secondary components. The primary component is secured to a first member of the vehicle, and the secondary components are secured to a second member of the vehicle. The primary component is individually tunable for different rate and progression characteristics than the secondary components. Each of the secondary components function in series with the primary component between the first and second members such that the mount assembly has a multi-rate adjustable static behavior along with the ability to similarly develop decoupled dynamic stiffness performance.

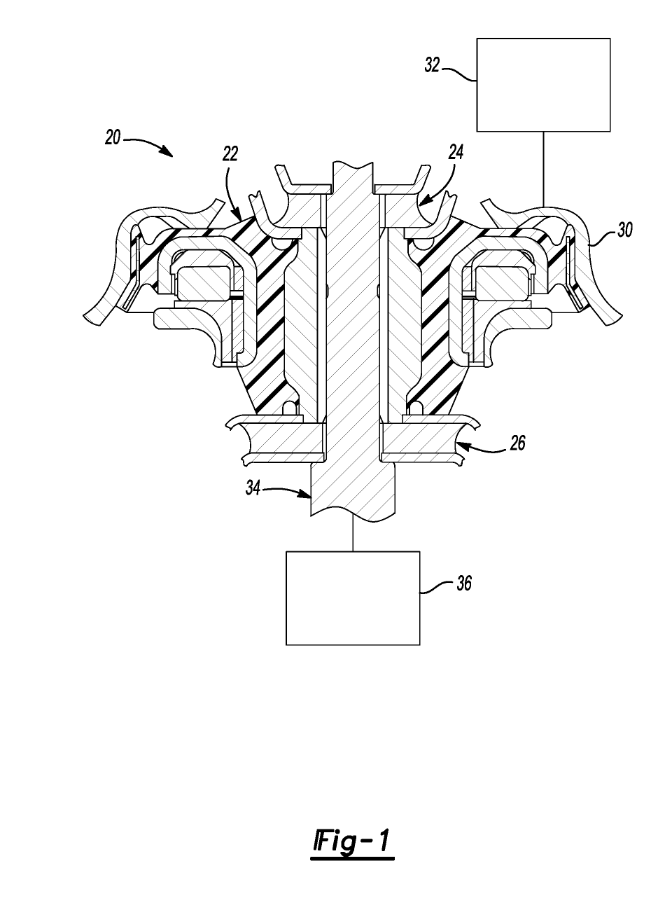

Referring to FIG. 1, a mount assembly 20 according to the principles of the present disclosure is schematically illustrated. Mount assembly 20 includes a primary component 22 and a pair of secondary components 24, 26. Primary component 22 is secured to a first member 30, which is coupled to a first vehicle sub-assembly 32. Secondary components 24, 26 are secured to a second member 34, which is coupled to a second vehicle sub-assembly 36.

Mount assembly 20 is described in detail herein with first vehicle sub-assembly 32 in the form of a vehicle frame assembly and second vehicle sub-assembly 36 in the form of a vehicle suspension system. It should be understood that a mount assembly according to the principles of the present disclosure can be used in a variety of vehicle applications. Therefore, it should be understood that the description herein of mount assembly 20 equally applies to other applications thereof.

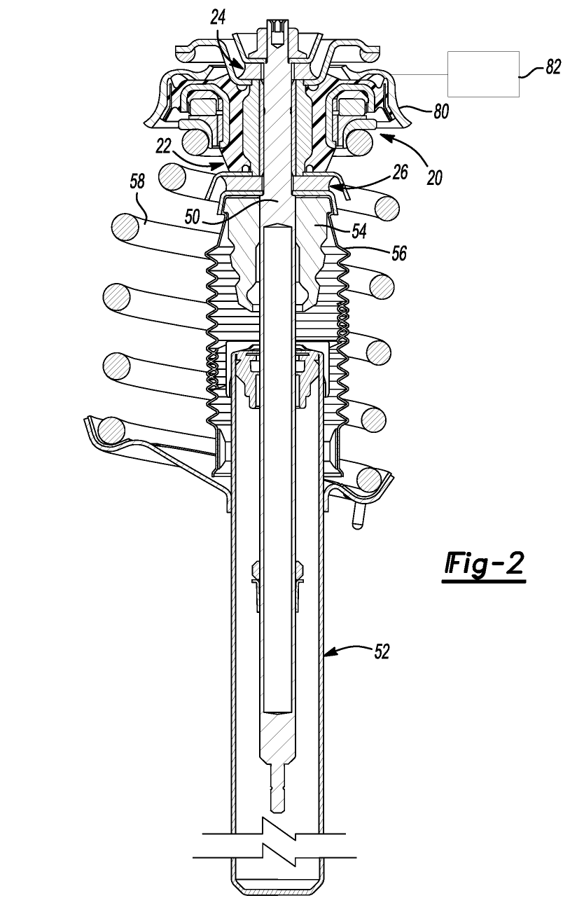

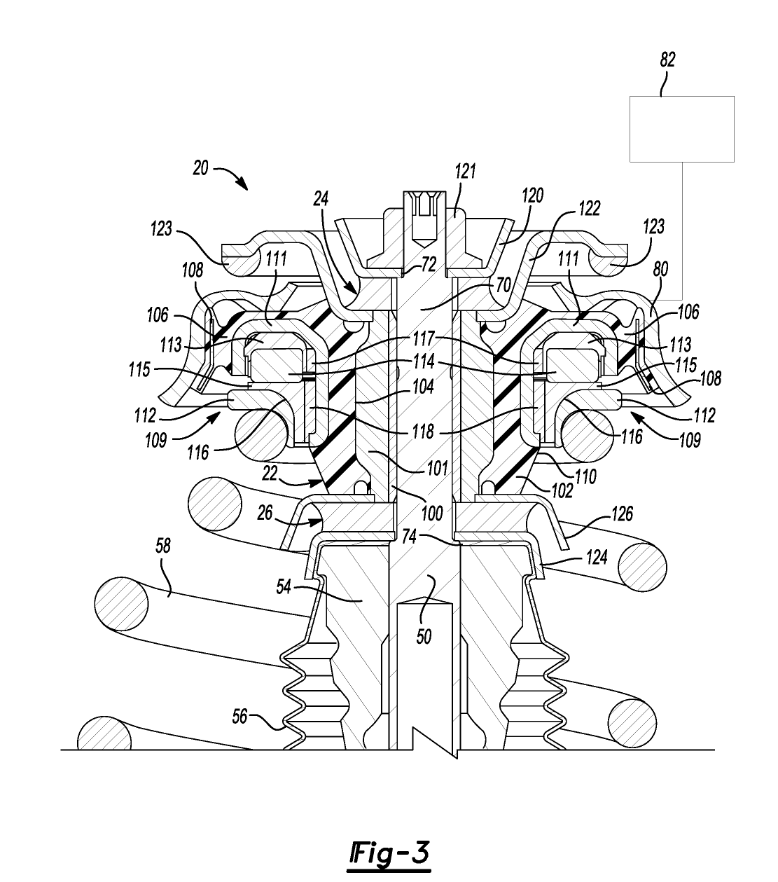

Referring to FIGS. 2-3, mount assembly 20 is illustrated as a strut top mount for a vehicle suspension system. Mount assembly 20 is disposed on a strut rod 50 extending from a strut 52. A jounce bumper 54 and a dust boot 56 are also disposed on strut 52. Additionally, a coil spring 58 extends around strut 52 and engages mount assembly 20. The configuration and operation of these components of a vehicle suspension system are well known to those of ordinary skill in the art and, therefore, will not be described in further detail herein.

According to the principles of the present disclosure, mount assembly 20 is coupled to a top portion 70 of strut rod 50, as best illustrated in FIG. 3. Top portion 70 is defined between an upper step feature 72 and a lower step feature 74 of strut rod 50. As described in more detail herein, this stepped geometry of strut rod 50 provides for positive locations of secondary components 24, 26 of mount assembly 20. Other methods of locating the mount assembly 20 can also be utilized.

In this exemplary embodiment, primary component 22 of mount assembly 20 is fixed to a vehicle frame component 80. Vehicle frame component 80, in turn, is fixed to a vehicle frame or vehicle frame assembly 82. In this regard, primary component 22 is similar to conventional strut top mounts. However, according to the principles of the present disclosure, primary component is slidably coupled to top portion 70 of strut rod 50. To facilitate such an engagement, a slide bushing 100 is disposed within primary component 22 and provides for relatively reduced friction between strut rod 50 and primary component 22. Alternatively, the sliding interface might be achieved by use of a composite core of a self-lubricating nature such as nylon or other known materials so that the slide bushing could be eliminated. Slide bushing 100 can be made of nylon, composite plastic, brass, or other similar bushing-type material with good friction wear characteristics by way of non-limiting example.

Primary component 22 further includes a sleeve 101 and a main portion 102. Sleeve 101 has a generally cylindrical shape and is directly attached to slide bushing 100. Both slide bushing 100 and sleeve 101 directly engage each of secondary components 24, 26. Furthermore, main portion 102 has a generally cylindrical shape and is disposed around sleeve 101. In particular, an inside surface 104 of main portion 102 is complementary to the exterior of sleeve 101 to prevent relative axial motion therebetween.

Main portion 102 also includes a radially extending upper portion 106. Upper portion 106 extends outwardly and supports vehicle frame component 80. A narrowly-shaped insert 108 is disposed within an outer part of upper portion 106. Insert 108 is relatively rigid and provides support to upper portion 106.

Main portion 102 can be tuned to provide specific performance characteristics of primary component 22. For example, main portion 102 can be made of a variety of materials. In particular, main portion 102 can include an elastomeric material such as rubber, by way of non-limiting example. Primary component 22 can further be similar to conventional strut top mounts in that main portion 102 can be tuned to provide primary component 22 with a relatively high stiffness.

Additionally, a spring seat assembly 109 is coupled to main portion 102 of primary component 22 between upper portion 106 and a flange portion 110 to provide an interface with coil spring 58. In particular, a curved seat housing 111 is directly engaged with main portion 102, and a seat plate 112 is directly engaged with coil spring 58. A top member 113, a first bearing member 114, and a second bearing member 115 are vertically aligned between seat housing 111 and seat plate 112. Top member 113 has a downwardly-facing C-shaped cross section complementary to first bearing member 114, and second bearing member 115 has a downwardly-facing L-shaped cross section having an arcuate surface 116 complementary to seat plate 112. Furthermore, spring seat assembly 109 includes top and bottom spacer components 117, 118 radially disposed between seat housing 111 and top and bottom members 113, 115, respectively. The purpose of the spring seat assembly 109 is to positively locate and secure the coil spring 58 relative to the mount input path. Bearing members 114-115 define a race-type ball bearing that allows the spring 58 to move freely in rotation relative to the mount 20. This prevents binding during major inputs.

According to the principles of the present disclosure, secondary components 24, 26 of mount assembly 20 are sandwiched around primary component 22. In this exemplary embodiment, secondary components 24, 26 are disposed proximate upper and lower step features 72, 74, respectively. As such, these components can be individually referred to herein as upper secondary component 24 and lower secondary component 26. It should be understood that, unless otherwise noted herein, a description of one of secondary components 24, 26 equally applies to the other of these components.

Upper secondary component 24 is positioned proximate upper step feature 72. In particular, an upper plate 120 is fixed at upper step feature 72 by a fastener 121 disposed around strut rod 50. As such, upper plate 120 provides a positive location for upper secondary component 24. Upper plate 120 has a generally concave shape oriented away from upper secondary component 24 so as to extend around fastener 121. Furthermore, a cover plate 122 is disposed between upper secondary component 24 and main body 102 of primary component 22 to provide an interface for the engagement of upper secondary component 24 and main body 102. Cover plate 122 is disposed around the ends of slide bushing 100 and sleeve 101 to allow slide bushing 100 and sleeve 101 to directly contact upper secondary component 24. Cover plate 122 also has a generally concave shape extending upwardly around upper secondary component 24 and upper plate 120. Additionally, cover plate 122 has a rounded protrusion 123 disposed at the radially outward end thereof.

Similarly, lower secondary component 26 is positioned proximate lower step feature 74. In particular, a lower plate 124 engages lower step feature 74 to provide a positive location for lower secondary component 26. Lower plate 124 has a generally concave shape oriented away from lower secondary component 26 so as to extend around a part of jounce bumper 54 and dust boot 56. Furthermore, a cover plate 126 is disposed between lower secondary component 26 and main body 102 of primary component 22 to provide an interface for the engagement of lower secondary component 26 and main body 102. Cover plate 126 is disposed around the ends of slide bushing 100 and sleeve 101 to allow slide bushing 100 and sleeve 100 to directly contact lower secondary component 26. Cover plate 126 also has a generally concave shape extending downwardly around lower secondary component 26 and lower plate 124. Upper plate 120 and lower plate 124 are fixed relative to one another and define outside element stoppers for the mount assembly 20.

In this exemplary embodiment, secondary components 24, 26 have generally annular shapes. However, it should be understood that secondary components 24, 26 can be individually sized or otherwise configured. For example, upper secondary component 24 is narrower than lower secondary component 26 in order to complement the configuration of primary component 22. It should be understood that each of secondary components as well as primary component 22 can have a variety of sizes, geometries, and configurations.

Furthermore, according to the principles of the present disclosure, secondary components 24, 26 can be tuned to provide specific performance characteristics different than the performance characteristics of primary component 22. In particular, as described herein, primary component 22 can be individually tuned to have a relatively high stiffness. Therefore, secondary components 24, 26 can be tuned to have relatively low stiffnesses. For example, as primary component 22 can be made of an elastomeric material such as rubber, secondary components 24, 26 can be made of a material such as microcellular urethane (MCU) to provide relatively lower stiffnesses. Furthermore, the geometry and size of the primary and secondary components 22, 24, 26 can be varied to tune the mount performance to provide desired characteristics.

It should be understood that secondary components 24, 26 can include a variety of materials. Furthermore, it should be understood that, according to the principles of the present disclosure, secondary components 24, 26 can be tuned to have different performance characteristics and, therefore, can be made of and/or include different materials and geometries.

According to the principles of the present disclosure, mount assembly 20 provides multi-rate decoupled dynamic stiffness performance between strut rod 50 and vehicle frame component 80 and, therefore, the vehicle suspension system and the vehicle frame. In particular, with primary component 22 having a relatively high stiffness and secondary components 24, 26 having relatively low stiffnesses and with each of secondary components 24, 26 engaged in series with primary component 22 between strut rod 50 and vehicle frame component 80, mount assembly 20 has different behaviors in response to relatively high forces and relatively low forces applied between strut rod 50 and vehicle frame component 80.

For example, if a downward force is applied to strut rod 50, a force translation path is defined between strut rod 50 and vehicle frame component 80 in series through upper secondary component 24 and primary component 22. If the downward force has a relatively low amplitude, primary component 22, which has a relatively high stiffness, behaves similarly to a rigid component, and upper secondary component 24 deforms in response. If the downward force has a relatively high amplitude, upper secondary component 24 deforms to a maximum compression, and primary component 22 deforms in response. In each case, primary component 22 slides relative to strut rod 50 to accommodate the deformation of upper secondary component 24.

Primary component 22 and lower secondary component 26 similarly function in response to upward forces applied between strut rod 50 and vehicle frame component 80. As such, mount assembly 20 can function with different behaviors depending on the amplitude of the forces applied thereto. Therefore, a mount assembly according to the principles of the present disclosure has multi-rate decoupled dynamic stiffness performance with functionality over a broad range of forces.

The present disclosure can vary in many ways. For example, a mount assembly according to the principles of the present disclosure can be used in a variety of applications. As such, a mount assembly according to the principles of the present disclosure can have a variety of configurations. Furthermore, the components of a mount assembly according to the principles of the present disclosure can be made of and/or include a variety of materials and can have a variety of configurations. Accordingly, it should be understood that the present disclosure is exemplary in nature.

What is claimed is:

1. A mount assembly comprising:
a first vibration absorbing component secured to a first member, said first vibration absorbing component having first tuned performance characteristics;
a second vibration absorbing component secured to a second member, said second vibration absorbing component having second tuned performance characteristics different than said first tuned performance characteristics, said second vibration absorbing component engaged in series with said first vibration absorbing component for transmitting forces between said first and second members; and
a third vibration absorbing component secured to said second member, said third vibration absorbing component having third tuned performance characteristics different than said first tuned performance characteristics, said third vibration absorbing component engaged in series with said first vibration absorbing component for transmitting forces between said first and second members, said first vibration absorbing component being disposed between said second and third vibration absorbing components.

2. The mount assembly of claim 1, wherein said first tuned performance characteristics is greater than said second and third tuned performance characteristics.

3. The mount assembly of claim 2, wherein said second and third tuned performance characteristics are equal.

4. The mount assembly of claim 2, wherein said second and third tuned performance characteristics are different from each other.

5. The mount assembly of claim 1, wherein said first vibration absorbing component is movably coupled to said second member.

6. The mount assembly of claim 5, wherein said first vibration absorbing component has a slide bushing disposed therein configured to engage said second member.

7. The mount assembly of claim 1, wherein said first vibration absorbing component includes an elastomeric material.

8. The mount assembly of claim 1, wherein at least one of said second and third vibration absorbing components includes microcellular urethane.

9. The mount assembly of claim 1, wherein said first member is a vehicle frame, and said second member is a strut rod for a vehicle suspension system.

10. A vehicle suspension assembly comprising:
a vehicle frame adapted to support a body of a vehicle;
a strut rod adapted to be coupled to a vehicle suspension system;
a first vibration absorbing mount component secured to said vehicle frame and slidably coupled to said strut rod, said first vibration absorbing mount component having a first tuned performance characteristics; and
second and third vibration absorbing mount components secured to said strut rod on opposite sides of said first vibration absorbing mount component, each of said second and third vibration absorbing mount components engaged in series with said first vibration absorbing mount component for transmitting forces between said vehicle frame and said strut rod, said second and third vibration absorbing mount components having second and third tuned performance characteristics, respectively, said first tuned performance characteristics being different than said second and third tuned performance characteristics.

11. The vehicle suspension assembly of claim 10, wherein said first stiffness is greater than said second and third tuned performance characteristics.

12. The vehicle suspension assembly of claim 11, wherein said second and third tuned performance characteristics are equal.

13. The vehicle suspension assembly of claim 11, wherein said second and third tuned performance characteristics are different from each other.

14. The vehicle suspension assembly of claim 10, wherein said strut rod includes an upper step portion and has a upper plate fixed at said upper step portion, one of said second and third vibration absorbing mount components engaging said upper plate.

15. The vehicle suspension assembly of claim 14, wherein said strut rod includes a lower step portion and has a lower plate fixed at said lower step portion, the other of said second and third vibration absorbing mount components engaging said lower plate.

16. The vehicle suspension assembly of claim 10, wherein said first vibration absorbing mount component has a bushing fixed therein, said bushing slidably engaging said strut rod.

17. A method of mounting a vehicle suspension system, the method comprising:
securing a primary vibration absorbing mount component to a vehicle frame;
movably coupling said primary vibration absorbing mount component to a member of the vehicle suspension system; and
positioning a pair of secondary vibration absorbing mount components on said member at opposing sides of said primary vibration absorbing mount component so that each of said secondary vibration absorbing mount components are engaged in series with said primary vibration absorbing mount component for transmitting forces between said vehicle frame and said member, said primary vibration absorbing mount component having a different tuned performance characteristics than said secondary vibration absorbing mount components.

18. The method of claim 17, wherein said primary vibration absorbing mount component has a greater stiffness than said secondary vibration absorbing mount components.

19. The method of claim 18, wherein said primary vibration absorbing mount component includes an elastomeric material and said secondary vibration absorbing mount components include microcellular urethane.

20. The method of claim 17, wherein said pair of secondary vibration absorbing mount components have different stiffnesses.
